(19) United States
(12) Patent Application Publication
(10) Pub. No.: US 2025/0010909 A1
(43) Pub. Date: Jan. 9, 2025

(54) VEHICLE STEERING DEVICE

(71) Applicant: HL MANDO CORPORATION, Gyeonggi-do (KR)

(72) Inventors: Hyeonsu KIM, Gyeonggi-do (KR); Bongsung KO, Gyeonggi-do (KR)

(21) Appl. No.: 18/396,555

(22) Filed: Dec. 26, 2023

(30) Foreign Application Priority Data
Jul. 7, 2023 (KR) 10-2023-0088127

(51) Int. Cl. B62D 5/04; B62D 1/19; B62D 7/16; B62D 7/22

(52) U.S. Cl. CPC B62D 5/0448; B62D 1/19; B62D 7/163; B62D 7/226; B62D 3/126

(57) ABSTRACT

A vehicle steering device may prevent a return tube from falling off from a ball nut, being deformed or being damaged despite continuous steering during driving, allow a ball to correctly circulate to the ball nut through the return tube, and prevent the lubricant from leaking from the return tube to correctly transfer steering assistance force.

### CROSS-REFERENCE TO RELATED APPLICATION

This application claims priority from Korean Patent Application No. 10-2023-0088127, filed on Jul. 7, 2023, which is hereby incorporated by reference for all purposes as if fully set forth herein.

### BACKGROUND

### Field

Some embodiments of the present disclosure generally relate to a vehicle steering device and, more specifically, to a vehicle steering device that may prevent a return tube from falling off from a ball nut, being deformed or being damaged despite continuous steering during driving, may allow a ball to correctly circulate to the ball nut through the return tube, and may prevent the lubricant from leaking from the return tube to correctly transfer steering assistance force.

### Description of Related Art

A vehicle steering device includes a steering system comprising a steering wheel and two opposite wheels and an assistance power mechanism that supplies steering assistance power to the steering system.

A vehicle steering device may include a motor controlled by an electronic controller, a motor pulley fixed to a motor shaft, a ball nut that is connected to a rack bar via balls, a return tube coupled to the ball nut to circulate balls therethrough, a nut pulley coupled to the outer circumferential surface of the ball nut, and a belt coupled to the motor pulley and the nut pulley.

In the conventional vehicle steering device, the return tube may fall off, be deformed, or be damaged due to vibration generated when the ball is circulated between the return tube and the ball nut by continuous steering during driving and impact from the road.

Further, when the return tube is not correctly fixed or located to the ball nut, the ball may not properly circulate, thereby decreasing steering assistance force and power transfer efficiency, with the result of a failure in correct transfer of steering assistance force.

Further, the leakage of ball lubricant may occur when the return tube circulates, and may disturb circulation of the ball and resultantly cause discontinuous power transfer.

Therefore, a need exists for research for addressing the foregoing issues.

It is with respect to these and other general considerations that the following embodiments have been described. Also, although relatively specific problems have been discussed, it should be understood that the embodiments should not be limited to solving the specific problems identified in the background.

### BRIEF SUMMARY

Conceived in the foregoing background, some embodiments of the present disclosure provide a vehicle steering device that may prevent a return tube from falling off from a ball nut, being deformed or being damaged despite continuous steering during driving, allow the ball to correctly circulate to the ball nut through the return tube, and prevent the lubricant from leaking from the return tube to correctly transfer steering assistance force.

According to the present embodiments, there may be provided a vehicle steering device, comprising a ball nut having an inner circumferential screw groove disposed to face an outer circumferential screw groove of a rack bar and having a first communication hole and a second communication hole penetrating an inner circumferential surface and an outer circumferential surface and disposed on a first side and a second side of the inner circumferential screw groove and a return tube having body portions formed of a first member and a second member symmetrical to each other to form a ball circulation path communicating with the first communication hole and the second communication hole in coupled inner surfaces, wherein a first end portion of the body portion is coupled to the first communication hole, and a second end portion of the body portion is coupled to the second communication hole to circulate a ball, wherein coupling flanges coupled to face each other are formed on respective body portion outer surfaces of the first member and the second member, and wherein a coupling protrusion is formed on any one of the coupling flanges to protrude in a facing direction, and a coupling hole to which the coupling protrusion is fitted is formed in another one of the coupling flanges.

In the present embodiments, the coupling flanges may include two or more coupling flanges formed in the respective body portions of the first member and the second member.

In the present embodiments, the coupling flanges may include an even number of two or more coupling flanges formed in the respective body portions of the first member and the second member.

In the present embodiments, the coupling flanges may come in surface contact with each other while the body portions of the first member and the second member are coupled to each other.

In the present embodiments, the respective body portions of the first member and the second member may have coupling surfaces that come in surface contact with each other while forming the ball circulation path.

In the present embodiments, an elastic member elastically compressed when the first member and the second member are coupled to each other may be coupled between the coupling surfaces of the first member and the second member.

In the present embodiments, the elastic member may be integrally formed with the coupling surface of either the first member or the second member.

In the present embodiments, the elastic member may be coupled by an adhesive, or fused, to the coupling surface of either the first member or the second member.

In the present embodiments, the coupling protrusion may include an insertion supporting portion connected to the coupling flange and supported on an inner circumferential surface of the coupling hole and an outer supporting portion extending from the insertion supporting portion in a length direction and a radial direction and protruding outward of the coupling hole to be supported on an outer surface of the coupling flange having the coupling hole.

In the present embodiments, the coupling protrusion may have a cutout portion symmetrically separating the insertion supporting portion and the outer supporting portion.

In the present embodiments, a connecting rib connecting the insertion supporting portion may be provided on the cutout portion.

According to the present embodiments, there may be provided a vehicle steering device, comprising a ball nut having an inner circumferential screw groove disposed to face an outer circumferential screw groove of a rack bar and having a first communication hole and a second communication hole penetrating an inner circumferential surface and an outer circumferential surface and disposed on a first side and a second side of the inner circumferential screw groove and a return tube having body portions formed of a first member and a second member symmetrical to each other to form a ball circulation path communicating with the first communication hole and the second communication hole in coupled inner surfaces, wherein a first end portion of the body portion is coupled to the first communication hole, and a second end portion of the body portion is coupled to the second communication hole to circulate a ball, wherein coupling flanges coupled to face each other are formed on respective body portion outer surfaces of the first member and the second member, wherein a coupling protrusion is formed on any one of the coupling flanges to protrude in a facing direction, and a coupling hole to which the coupling protrusion is fitted is formed in another one of the coupling flanges, wherein a fastening protrusion is formed in any one of the body portions of the first member and the second member, and a fastening groove to which the fastening protrusion is inserted is formed in the other.

In the present embodiments, the fastening protrusion may be formed on an entire edge of the body portion of the first member, and the fastening groove may be formed in an entire edge of the body portion of the second member.

In the present embodiments, the fastening protrusion may be formed in a partial area of the edge of the body portion of the first member, and the fastening groove may be formed in a remaining area of the edge.

In the present embodiments, the fastening protrusion and the fastening groove may be fitted to each other while coming in surface contact with each other.

In the present embodiments, the coupling flanges may include two or more coupling flanges formed in the respective body portions of the first member and the second member.

In the present embodiments, the coupling flanges may include an even number of two or more coupling flanges formed in the respective body portions of the first member and the second member.

In the present embodiments, the coupling flanges may come in surface contact with each other while the body portions of the first member and the second member are coupled to each other.

In the present embodiments, the coupling protrusion may include an insertion supporting portion connected to the coupling flange and supported on an inner circumferential surface of the coupling hole and an outer supporting portion extending from the insertion supporting portion in a length direction and a radial direction and protruding outward of the coupling hole to be supported on an outer surface of the coupling flange having the coupling hole.

In the present embodiments, the coupling protrusion may have a cutout portion symmetrically separating the insertion supporting portion and the outer supporting portion.

According to certain embodiments of the present disclosure, a vehicle steering device may prevent a return tube from falling off from a ball nut, being deformed or being damaged despite continuous steering during driving, allow a ball to correctly circulate to the ball nut through the return tube, and prevent the lubricant from leaking from the return tube to correctly transfer steering assistance force.

### BRIEF DESCRIPTION OF DRAWINGS

The above and other objects, features, and advantages of the disclosure will be more clearly understood from the following detailed description, taken in conjunction with the accompanying drawings, in which:

FIG. 1 is a view for schematically illustrating a vehicle steering device according to an embodiment of the present disclosure;

FIGS. 2 and 3 are perspective views for illustrating some parts of a vehicle steering device according to an embodiment of the present disclosure;

FIG. 4 is an exploded perspective view for illustrating some parts of a vehicle steering device according to an embodiment of the present disclosure;

FIGS. 5 and 6 are exploded perspective view for illustrating some parts of a return tube according to an embodiment of the present disclosure;

FIGS. 7 and 8 are partial views for illustrating a return tube according to an embodiment of the present disclosure;

FIGS. 9 and 10 are partial cross-sectional views for illustrating a return tube according to an embodiment of the present disclosure;

FIGS. 11 to 13 are perspective views for illustrating a member of a return tube according to an embodiment of the present disclosure;

FIG. 14 is a front view for illustrating a return tube according to an embodiment of the present disclosure; and

FIG. 15 is a cross-sectional view taken along line A-A of FIG. 14.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

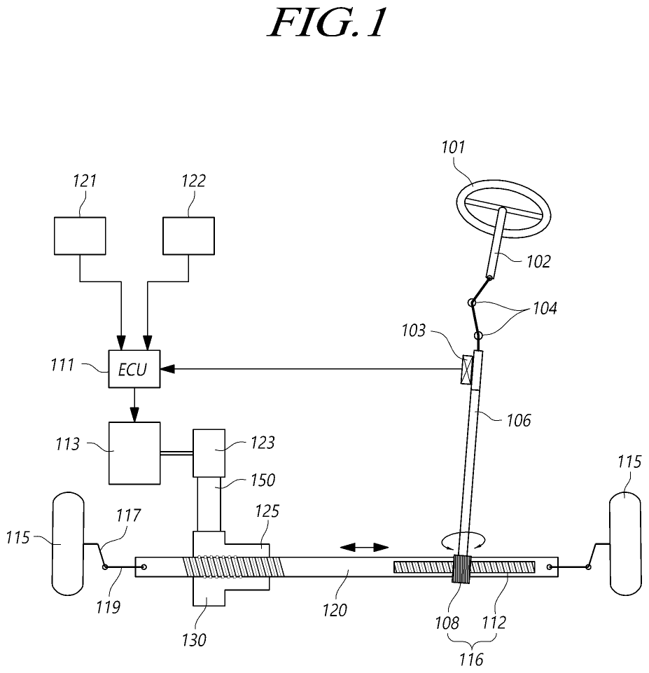

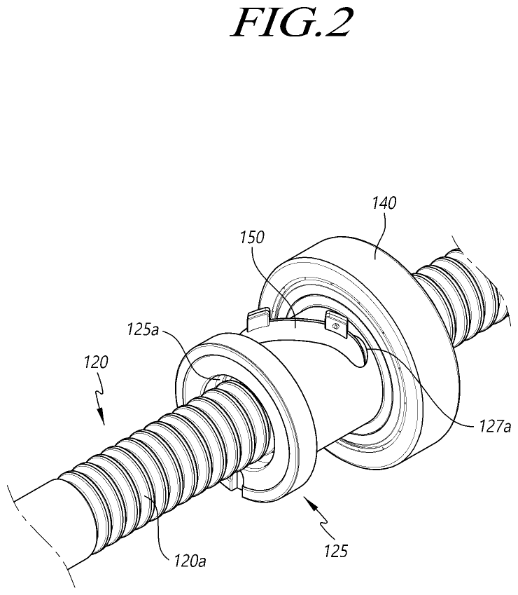

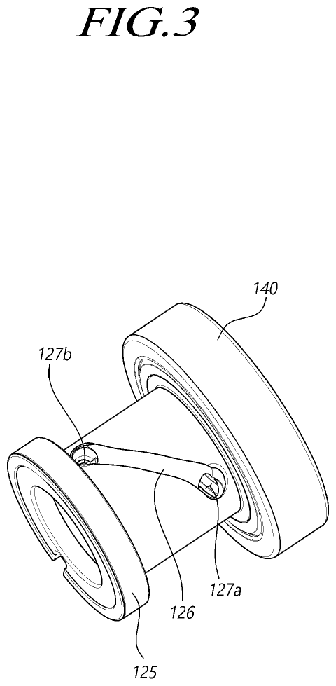

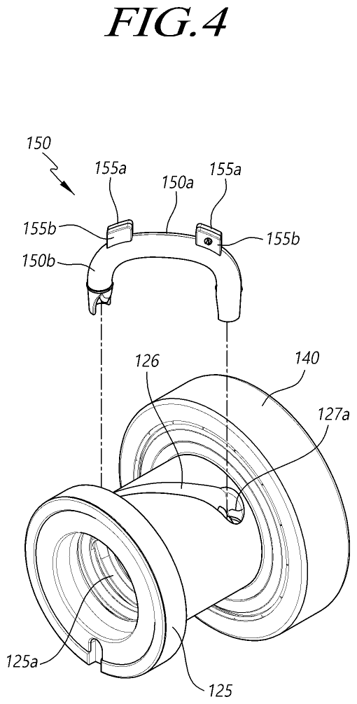

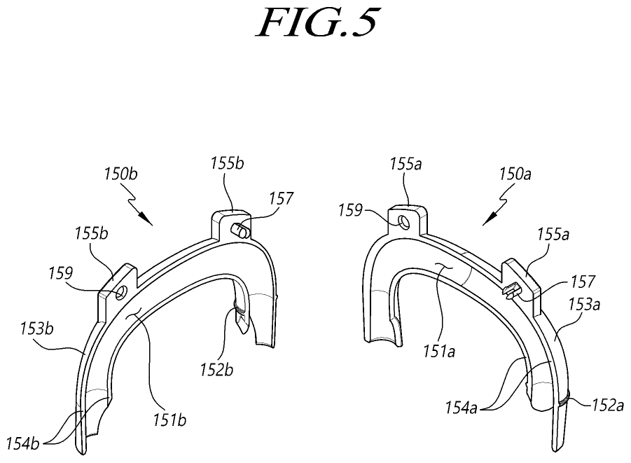

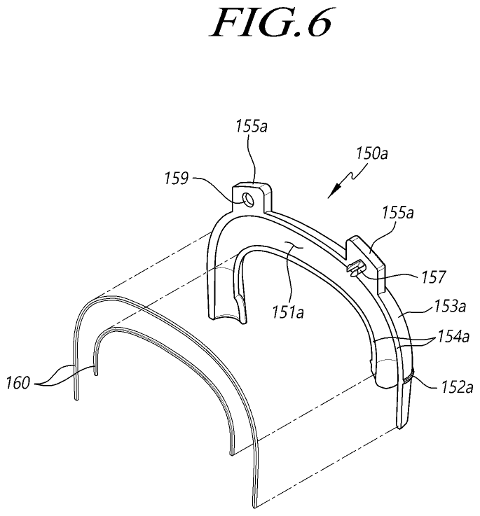

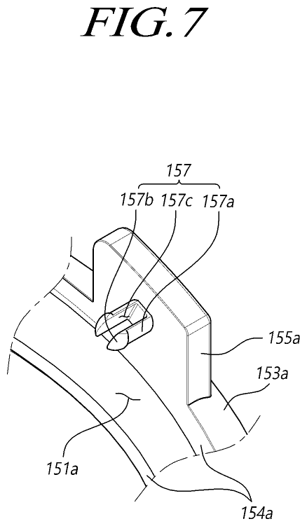

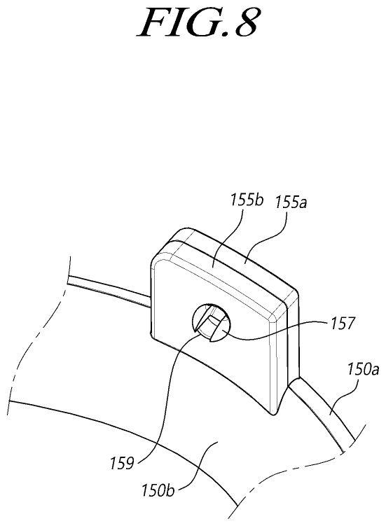

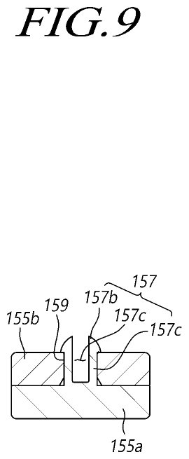

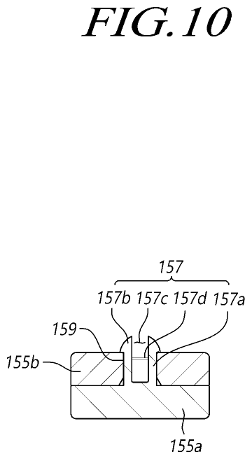

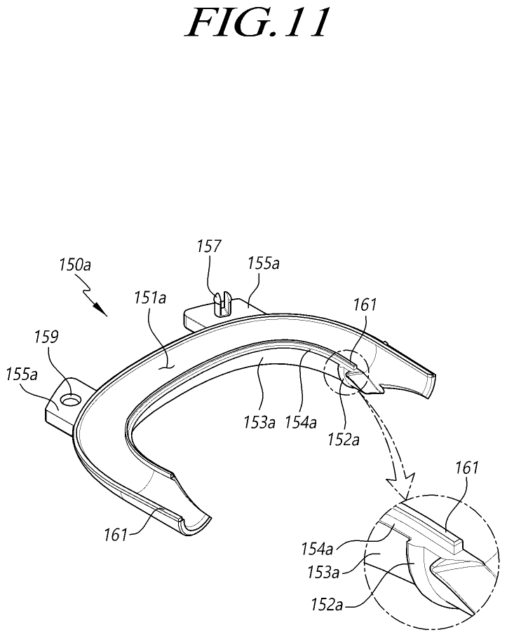

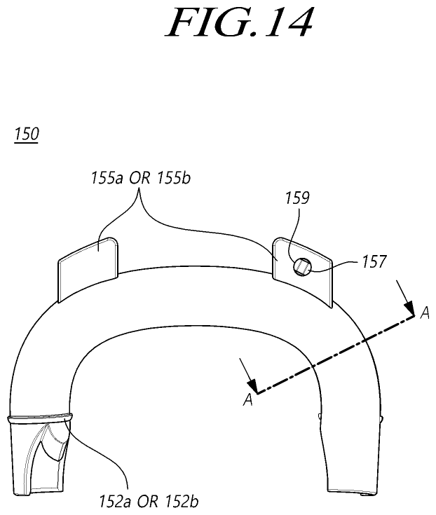

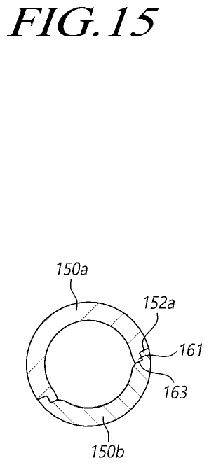

FIG. 1 is a view for schematically illustrating a vehicle steering device according to an embodiment of the present disclosure. FIGS. 2 and 3 are perspective views for illustrating some parts of a vehicle steering device according to an embodiment of the present disclosure. FIG. 4 is an exploded perspective view for illustrating some parts of a vehicle steering device according to an embodiment of the present disclosure. FIGS. 5 and 6 are exploded perspective view for illustrating some parts of a return tube according to an embodiment of the present disclosure. FIGS. 7 and 8 are partial views for illustrating a return tube according to an embodiment of the present disclosure. FIGS. 9 and 10 are partial cross-sectional views for illustrating a return tube according to an embodiment of the present disclosure. FIGS. 11 to 13 are perspective views for illustrating a member of a return tube according to an embodiment of the present disclosure. FIG. 14 is a front view for illustrating a return tube according to an embodiment of the present disclosure. FIG. 15 is a cross-sectional view taken along line A-A of FIG. 14.

Referring to FIGS. 1 to 10, a vehicle steering device according to some embodiments of the present disclosure may include a ball nut 125 and a return tube 150. The ball nut 125 has an inner circumferential screw groove or threads 125a disposed or formed to face an outer circumferential screw groove or threads 120a of a rack bar 120. The ball nut 125 has a first communication hole 127a and a second communication hole 127b penetrating an inner circumferential surface and an outer circumferential surface of the ball nut 125 and disposed or formed on a first side and a second side of the inner circumferential screw groove 125a. The return tube 150 may have body portions 153a and 153b, comprised in a first member 150a and a second member 150b symmetrical to each other, to form a ball circulation path 151a and 151b communicating with the first communication hole 127a and the second communication hole 127b. First end portions of the body portions 153a and 153b are inserted into and coupled to the first communication hole 127a, and second end portions of the body portions 153a and 153b are inserted into and coupled to the second communication hole 127b to circulate balls. Coupling flanges or tabs 155a and 155b coupled to face each other are formed on outer surfaces of the body portions 153a and 153b of the first member 150a and the second member 150b, respectively. A coupling protrusion 157 is formed on one of the coupling flanges 155a to protrude in a direction toward one of the coupling flanges 155b and another coupling protrusion 157 is formed on one of the coupling flanges 155b to protrude in a direction toward one of the coupling flanges 155a. A coupling hole 159 to which the coupling protrusion 157 is fitted is formed in another one of the coupling flanges 155a and 155b.

In the vehicle steering device according to an embodiment of the present disclosure, a torque sensor 103 is coupled to one side of steering shafts 102 and 106 connected with a steering wheel 101. When a driver manipulates or rotates the steering wheel 101, electrical signals are sent to an electronic control unit (ECU) 111 or the motor 113 from the torque sensor 103, steering angle sensor 121, and/or vehicle velocity sensor 122 detecting the manipulation of the driver, in order to assist or control the steering of the two opposite road wheels 115.

In the vehicle steering device according to an embodiment of the present disclosure, the upper steering shaft 102 is connected to the lower steering shaft 106 through a universal joint 104 so that the steering can be performed through a rack-pinion mechanism 116 having a pinion 108 and a rack gear 112.

Here, the driving power of the motor 113 driven or controlled by the electronic control unit 111 is transferred to the ball nut 125 through the motor 113 and the belt 150. The rack bar 120 coupled to the ball nut 125 is configured to be axially slidable via a ball screw-nut mechanism. Tie rods 119 are coupled to two opposite sides of the rack bar 120, and the tie rods 119 are coupled to knuckle arms 117 connected to road wheels 115 to steer the road wheels 115.

The electric signal generated from the torque signal 103 is sent to the ECU 111, and the ECU 111 controls the motor 113 based on at least one of the electric signal received from the torque sensor 103 and the electric signals received from the steering angle sensor 121 and the vehicle speed sensor 122 mounted to the vehicle.

Although an exemplary embodiment of the present disclosure includes a torque sensor 103, a steering angle sensor 121, and a vehicle velocity sensor 122 for convenience of description, an angle sensor, a motor position sensor, various radars or lidars, or image sensors, such as cameras, may be additionally or alternatively provided.

A power transmission structure is provided or arranged on the outer circumferential surface of the rack bar 120 and the inner circumferential surface of the ball nut 125 to axially or linearly slide the rack bar 120 to generate steering assist power for assisting the steering. The power transmission structure includes an outer circumferential screw groove or thread 120a spirally formed in or on the outer circumferential surface of the rack bar 120 and having a substantially semi-circular or arc-shaped cross section, an inner circumferential screw groove or thread 125a spirally formed in or on the inner circumferential surface of the ball nut 125 to correspond to the outer circumferential screw groove 120a and having a substantially semi-circular or arc-shaped cross section, and one or more balls rotatably disposed between the ball nut 125 and the rack bar 120.

In the ball nut 125 having the inner circumferential screw groove or thread 125a formed in or on the inner circumferential surface thereof, the first communication hole 127a and the second communication hole 127b penetrating the inner circumferential surface and outer circumferential surface of the ball nut 125 make a pair and are disposed to be spaced apart from each other along the inner circumferential screw groove or thread 125a.

Therefore, balls which roll along or between the outer circumferential screw groove or thread 120a and the inner circumferential screw groove or thread 125a can be moved from the first communication hole 127a to the second communication hole 127b of the ball nut 125 and are then circulated through the ball circulation paths 151a and 151b of the return tube 150 to the first communication hole 127a.

For example, the return tube 150 is shaped substantially like the letter “U” and has a gentle curve without a straight portion from one end to the opposite end and includes a pair of the first member 150a and the second member 150b symmetrical to each other with respect to the central line of the return tube 150.

The return tube 150 includes the body portions 153a and 153b forming the ball circulation paths 151a and 151b formed by the inner surfaces of the first member 150a and the second member 150b coupled to each other. First end portions of the body portions 153a and 153b are coupled to the first communication hole 127a of the ball nut 125, and second end portions of the body portions 153a and 153b are coupled to the second communication hole 127b of the ball nut 125.

Further, a seating groove 126 for connecting the first communication hole 127a and the second communication hole 127b is formed in or on the outer circumferential surface of the ball nut 125 to seat the return tube 150 to remain in place.

The return tube 150 may be formed of a plastic resin, for example, but not limited to, polyacetal (POM), polyamide (PA), polycarbonate (PC), polyimide (PI), polybutylene terephthalate (PBT), polyphenylene sulfide (PPS), or phenol formaldehyde (PF), or a metal material.

The coupling flanges or tabs 155a and 155b coupled to each other are formed on the outer surfaces of the body portions 153a and 153b of the first member 150a and the second member 150b, respectively. A coupling protrusion 157 protruding toward another coupling flange or tab having the coupling hole 159 is formed in or at one of the coupling flanges 155a and 155b, and the coupling hole 159 to which the coupling protrusion 157 is coupled is formed at another coupling flange or tab.

In other words, if the coupling protrusion 157 is formed in or at the coupling flange 155a of the body portion 153a of the first member 150a, the coupling hole 159 is formed in or at the coupling flange 155b of the body portion 153b of the second member 150b, so that the coupling protrusion 157 of the first member 150a can be inserted into the coupling hole 159 of the second member 150b and the first member 150a and the second member 150b are coupled to each other through the coupling protrusion 157 and the coupling hole 159.

Each of the body portions 153a and 153b of the first member 150a and the second member 150b may have two or more coupling flanges such as 155a and 155b.

Each of the body portions 153a and 153b of the first member 150a and the second member 150b may have an even number of coupling flanges, although not required.

In an exemplary embodiment of the present disclosure that an even number of coupling flanges are formed, the first member 150a and the second member 150b may be formed by one mold, thereby reducing manufacturing costs and simplifying a manufacturing process.

As the coupling flanges 155a and 155b of the body portions 153a and 153b of the first member 150a and the second member 150b coupled to each other come in surface-contact with each other, the watertightness of the first member 150a and the second member 150b can be improved and the leakage of lubricant from the return tube 150 while the balls circulate can be prevented.

The body portions 153a and 153b of the first member 150a and the second member 150b may have coupling surfaces 154a and 154b which come in surface-contact with each other while forming the ball circulation paths 151a and 151b, and one or more elastic member 160 are disposed between the coupling surfaces 154a and 154b of the first member 150a and the second member 150b and are elastically compressed when the first member 150a and the second member 150b.

If the coupling protrusion 157 is fitted or inserted into the coupling hole 159, the elastic member 160 is elastically compressed while being supported on the coupling surfaces 154a and 154b of the first member 150a and the second member 150b and, in this state, if one end portion and another end portion of the return tube 150 are inserted into or coupled to the first communication hole 127a and the second communication hole 127b, the elastic member 160 may be further compressed.

Accordingly, by positioning the elastic members 160 between the coupling surfaces 154a and 154b of the first member 150a and the second member 150b, the watertightness of the first member 150a and the second member 150b may be increased, and the leakage of the lubricant from the return tube 150 when the balls are circulated may be prevented.

The elastic member 160 may be integrally formed with one of the coupling surfaces 154a and 154b of the first member 150a and the second member 150b and may be coupled, via an adhesive, or fused, to the other of the coupling surfaces 154a and 154b of the first member 150a and the second member 150b.

Here, the elastic member 160 may be formed of a material capable of absorbing vibration and noise while having a certain degree of elasticity and rigidity. For instance, the elastic member 160 may have an elastic material, such as natural rubber (NR), nitrile butadiene rubber (NBR), chloroprene rubber (CR), ethylene propylene terpolymer (EPDM), fluoro rubber (FPM), styrene butadine rubber (SBR), chlorosulphonated polyethylene (CSM), urethane, or silicone, although not required.

The coupling protrusion 157 protruding from one of the coupling flange or tab 155a and 155b includes an insertion support portion 157a inserted into the coupling hole 159 of another of the coupling flange 155a and 155b and supported on or in the inner circumferential surface of the coupling hole 159 and an outer support portion 157b extending from the insertion support portion 157a in the length direction and radial direction and protruding outward of the coupling hole 159 to be supported on the outer surface of the coupling flange 155a and 155b having the coupling hole 159. The insertion support portion 157a may be disposed in the coupling hole 157, while the outer support portion 157b may be located out of the coupling hole 157. The outer diameter of the outer support portion 157b may be greater than the outer diameter of the insertion support portion 157a and/or the inner diameter of the coupling hole 157.

Further, the coupling protrusion 157 has a cutout portion 157c that symmetrically separates the insertion support portion 157a and the outer support portion 157b. For example, the cutout portion 157c may be formed at the center of the insertion support portion 157a and the outer support portion 157b.

Accordingly, while the coupling protrusion 157 is being inserted into the coupling hole 159, the insertion support portion 157a and the outer support portion 157b are elastically deformed toward the cutout portion 157c, thereby contributing to easy assembly of the coupling protrusion 157 and the coupling hole 159.

Further, as shown in FIG. 10, a connecting rib 157d may be provided in the cutout portion 157c of the coupling protrusion 157 to connect the insertion support portion 157a.

The connecting rib 157d has a pillar or plate shape to connect inner surfaces of the insertion support portion 157a. The connecting rib 157d may increase the restoring force by which the insertion support portion 157a and the outer support portion 157b elastically deformed to come toward the cutout portion 157c when the coupling protrusion 157 is inserted into the coupling hole 159 can be restored to their original position.

Accordingly, if the outer support portion 157b passes through the coupling hole 159 and is then positioned on the outer surface of the coupling flange 155a and 155b, the outer support portion 157b is easily restored to its original shape, thereby maintaining the fastening strength in the correct position without falling off from the coupling hole 159.

FIGS. 11 to 15 show a vehicle steering device according to another embodiment of the present disclosure.

The vehicle steering device according to an embodiment of the present disclosure may include a ball nut 125 and a return tube 150. The ball nut 125 may have the inner circumferential screw groove or thread 125a formed or disposed to face the outer circumferential screw groove or thread 120a of the rack bar 120. The ball nut 125 may have a first communication hole 127a and a second communication hole 127b penetrating an inner circumferential surface and an outer circumferential surface of the ball nut 125 and disposed on a first side and a second side of the inner circumferential screw groove or thread 125a. The return tube 150 may have body portions 153a and 153b, comprised in a first member 150a and a second member 150b symmetrical to each other, to form a ball circulation path 151a and 151b communicating with the first communication hole 127a and the second communication hole 127b of the ball nut 125. First end portions of the body portions 153a and 153b are inserted into and coupled to the first communication hole 127a, and second end portions of the body portions 153a and 153b are inserted into and coupled to the second communication hole 127b to circulate balls. Coupling flanges or tabs 155a and 155b coupled to face each other are formed on outer surfaces of the body portions 153a and 153b of the first member 150a and the second member 150b, respectively. A coupling protrusion 157 is formed on one of the coupling flanges 155a to protrude in a direction toward one of the coupling flanges 155b and another coupling protrusion 157 is formed on one of the coupling flanges 155b to protrude in a direction toward one of the coupling flanges 155a. A coupling hole 159 to which the coupling protrusion 157 is fitted is formed in another one of the coupling flanges 155a and 155b. A fastening protrusion 161 is provided in any one of the body portions 153a and 153b of the first member 150a and the second member 150b, and a fastening groove 163 to which the fastening protrusion 161 is inserted is provided in the other one of the body portions 153a and 153b of the first member 150a and the second member 150b.

Here, the ball nut 125 is the same as or substantial similar to that described above, and is not described below in detail. The following description focuses primarily on the configurations shown in FIGS. 11 to 15 which differ from the above-described configurations according to certain embodiments of the present disclosure.

Referring to the return tube 150 shown in FIGS. 11 to 15 along with FIGS. 2 to 10, the fastening protrusion 161 is provided in any one of the body portions 153a and 153b of the first member 150a and the second member 150b, and the fastening groove 163 to which the fastening protrusion 161 is inserted is provided in the other one of the body portions 153a and 153b of the first member 150a and the second member 150b.

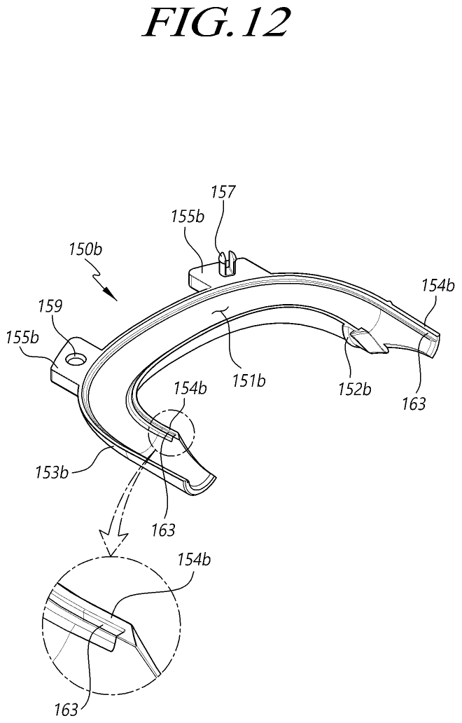

In an exemplary embodiment of the present disclosure, the fastening protrusion 161 may be provided in the entire edge of the body portion 153a of the first member 150a as shown in FIG. 11, and the fastening groove 163 may be provided in the entire edge of the body portion 153b of the second member 150b as shown in FIG. 12.

Thus, as the coupling protrusion 157 of the coupling flange 155a and 155b is fitted into the coupling hole 159 when the first member 150a and the second member 150b are coupled to each other, the fastening protrusion 161 and the fastening groove 163 of the body portion 153a and 153b are coupled to each other as well.

Alternatively, the fastening protrusion 161 and the fastening groove 163 may be formed at only the part of the edge of the body portions 153a and 153b of the first and second members 150a and 150b if necessary.

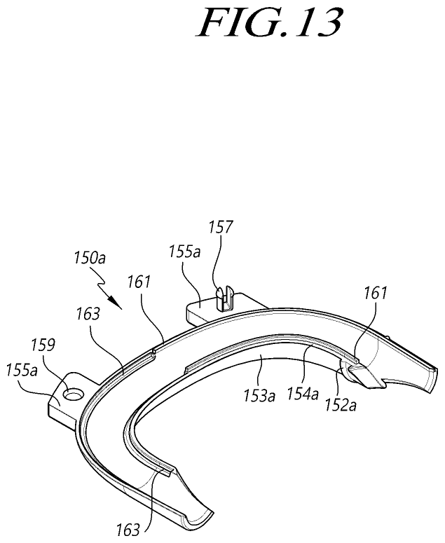

As shown in FIG. 13, the fastening protrusion 161 may be provided in a partial area of the edge of the body portion 153a of the first member 150a, and the fastening groove 163 may be provided in the remaining area of the edge of the body portion 153a of the first member 150a.

The first member 150a and the second member 150b may be formed in the same shape, and therefore may be formed using one mold, thereby reducing manufacturing costs and process.

The fastening protrusion 161 and the fastening groove 163 are coupled to each other while coming in surface-contact with each other. Accordingly, the watertightness of the first member 150a and the second member 150b may be increased, and the leakage of the lubricant from the return tube 150 when the balls are circulated may be prevented.

Each of the body portions 153a and 153b of the first member 150a and the second member 150b may have two or more coupling flanges or tabs 155a and 155b.

Further, an even number of coupling flanges may be formed in each of the body portions 153a and 153b of the first member 150a and the second member 150b. If an even number of coupling flanges are formed in each of the body portions 153a and 153b of the first member 150a and the second member 150b, the first member 150a and the second member 150b may be manufactured or formed using one mold, thereby reducing manufacturing costs and process.

As the coupling flanges or tabs 155a and 155b of the body portions 153a and 153b of the first member 150a and the second member 150b coupled to each other are coupled to each other while coming in surface-contact with each other, the watertightness of the first member 150a and the second member 150b can be improved and the leakage of lubricant from the return tube 150 while the balls circulate can be prevented.

The coupling protrusion 157 includes an insertion supporting portion 157a connected to the coupling flange 155a and 155b and supported on the inner circumferential surface of the coupling hole 159 and an outer supporting portion 157b extending from the insertion supporting portion 157a in the length direction and radial direction and protruding outward of the coupling hole 159 to be supported on the outer surface of the coupling flange 155a and 155b having the coupling hole 159.

The coupling protrusion 157 has the cutout portion 157c that symmetrically separates the insertion support portion 157a and the outer support portion 157b. For example, the cutout portion 157c may be formed at the center of the insertion support portion 157a and the outer support portion 157b. Thus, while the coupling protrusion 157 is being inserted into the coupling hole 159, the insertion support portion 157a and the outer supporting portion 157b are elastically deformed toward the cutout portion 157c, thereby facilitating the assembly of the return tube 150.

Meanwhile, supporting protrusions 152a and 152b are formed on two opposite end portions of the return tube 150. The supporting protrusions 152a and 152b protrude from the outer circumferential surface of the return tube 150 and are in tight contact with each other when fitted into the first communication hole 127a and the second communication hole 127b.

The supporting protrusions 152a and 152b radially protrude from the outer circumferential surface of the body portions 153a and 153b of the return tube 150 and, when the return tube 150 is assembled by coupling the first member 150a and the second member 150b to each other, the supporting protrusions 152a and 152b are elastically deformed and fitted into the first communication hole 127a and the second communication hole 127b, thereby maintaining their coupling without falling off from each other despite vibration and external impact due to the circulation of the balls.

The supporting protrusions 152a and 152b are formed on the first member 150a at an end portion of the return tube 150 and on the second member 150b at the other end portion of the return tube 150.

In other words, as the supporting protrusions 152a and 152b are formed in semi-circular shapes on the one end portion and the other end portion of the return tube 150, respectively, the fastening strength can be maintained while the entry of debris or powder into the ball nut 125 can be prevented even when the supporting protrusions 152a and 152b are broken during the assembly of the return tube 150.

A bearing 140 coupled to a gear housing to support the rotation of the ball nut 125 is coupled to one outer circumference-side end portion of the ball nut 125, and a nut pulley 130 is coupled to the other outer circumference-side end portion of the ball nut 125. The inner circumferential surface of the nut pulley 130 is spaced apart from the outer circumferential surface of the ball nut 125 to form a space or an air gap therebetween.

The nut pulley 130 coupled to the ball nut 125 is disposed parallel to the motor pulley 123 connected to the shaft of the motor 113, and the belt 150 is mounted on the motor pulley 123 and the nut pulley 130 to transfer the rotational force from the motor 113 to the rack bar 120 through the ball nut 125, and the rack bar 120 is moved to the left and right by the operation of the ball nut 125 to thus generate steering assistance force.

According to some embodiments of the present disclosure, a vehicle steering device may prevent a return tube from falling off from a ball nut, being deformed or being damaged despite continuous steering during driving, allow a ball to correctly circulate to the ball nut through the return tube, and prevent the lubricant from leaking from the return tube to correctly transfer steering assistance force.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A return tube comprising:
a first member comprising a first body portion; and
a second member comprising a second body portion,
wherein:
the first body portion and the second body portion are formed symmetrically to each other and coupled to each other to form a path for circulating balls,
a first end of the first and second body portions is coupled to a first hole of a ball nut and a second end of the first and second body portions is coupled to a second hole of the ball nut to circulate the balls in association with the ball nut,
flanges are formed at each of the first and second body portions to be coupled to each other and protrude from outer surfaces of the first and second body portions, and
a coupling hole is formed at one of the flanges and a coupling protrusion protrudes from an other of the flanges facing the one of the flanges at which the coupling protrusion is formed and is inserted in the coupling hole formed at the one of the flanges.

2. The return tube of claim 1, wherein the flanges include two or more flanges formed at each of the first and second body portions.

3. The return tube of claim 1, wherein the flanges include an even number of flanges formed at each of the first and second body portions.

4. The return tube of claim 1, wherein the one of the flanges and the other of the flanges facing each other are coupled to be in surface-contact with each other.

5. The return tube of claim 1, wherein the first and second body portions of the first and second members have coupling surfaces that are in surface-contact with each other to form the path for circulating the balls.

6. The return tube of claim 5, wherein an elastic material in a state of being elastically compressed is disposed between the coupling surfaces of the first and second body portions.

7. The return tube of claim 6, wherein the elastic material is integrally formed with one of the coupling surfaces of the first and second body portions.

8. The return tube of claim 6, wherein the elastic material is fixedly coupled or fused to one of the coupling surfaces of the first and second body portions.

9. The return tube of claim 1, wherein the coupling protrusion protruding from the other of the flanges includes:
an insertion support portion extending from the other of the flanges and supported on an inner circumferential surface of the coupling hole of the one of the flanges; and
an outer support portion extending from the insertion support portion, having an outer diameter larger than an inner diameter of the coupling hole of the one of the flanges, and protruding outward of the coupling hole of the one of the flanges to be supported on an outer surface of the one of the flanges having the coupling hole.

10. The return tube of claim 9, wherein the coupling protrusion has a cutout portion at a center of the insertion support portion and the outer support portion of the coupling protrusion.

11. The return tube of claim 10, wherein a connecting rib is disposed in the cutout portion of the coupling protrusion protruding from the other of the flanges.

12. A return tube comprising:
a first member comprising a first body portion; and
a second member comprising a second body portion,
wherein:
the first body portion and the second body portion are formed symmetrically to each other and coupled to each other to form a path for circulating balls,
a first end of the first and second body portions is coupled to a first hole of a ball nut and a second end of the first and second body portions is coupled to the second hole of the ball nut to circulate the balls in association with the ball nut,
flanges are formed at each of the first and second body portions to be coupled to each other and protrude from outer surfaces of the first and second body portions, and
a coupling hole is formed at one of the flanges and a coupling protrusion protrudes from an other of the flanges facing the one of the flanges at which the coupling protrusion is formed and is inserted in the coupling hole formed at the one of flanges, and
a fastening protrusion protrudes from one of the first and second body portions and a fastening groove is formed on an other of the first and second body portions such that the fastening protrusion is inserted in the fastening groove.

13. The return tube of claim 12, wherein the fastening protrusion is formed at an entire edge of the one of the first and second body portions and the fastening groove is formed at an entire edge of the other of the first and second body portions.

14. The return tube of claim 12, wherein the fastening protrusion is formed at a partial area of an edge of the one and the other of the first and second body portions and the fastening groove is formed at a remaining partial area of the edge of the one and the other of the first and second body portions.

15. The return tube of claim 12, wherein the fastening protrusion and the fastening groove are fitted to each other.

16. The return tube of claim 12, wherein the flanges include two or more flanges formed at each of the first and second body portions.

17. The return tube of claim 12, wherein the flanges include an even number of flanges formed at each of the first and second body portions.

18. The return tube of claim 12, wherein the one of the flanges and the other of the flanges facing each other are coupled to be in surface-contact with each other.

19. return tube of claim 12, wherein the coupling protrusion protruding from the other of the flanges includes:
an insertion support portion extending from the other of the flanges and supported on an inner circumferential surface of the coupling hole of the one of the flanges; and
an outer support portion extending from the insertion support portion, having an outer diameter larger than an inner diameter of the coupling hole of the one of the flanges, and protruding outward of the coupling hole of the one of the flanges to be supported on an outer surface of the one of the flanges having the coupling hole.

20. The return tube of claim 19, wherein the coupling protrusion has a cutout portion at a center of the insertion support portion and the outer support portion.
